(19) United States
(12) Patent Application Publication
(10) Pub. No.: US 2025/0054657 A1
(43) Pub. Date: Feb. 13, 2025

(54) ETHERNET CABLE

(71) Applicant: LS CABLE & SYSTEM LTD., Anyang-si, Gyeonggi-do (KR)

(72) Inventors: Woo Kyoung LEE, Suwon-si, Gyeonggi-do (KR); Young Il CHO, Osan-si, Gyeonggi-do (KR); Tae Hee KIM, Gumi-si, Gyeongsangbuk-do (KR); Jun LEE, Suwon-si, Gyeonggi-do (KR)

(21) Appl. No.: 18/701,512

(22) PCT Filed: Oct. 20, 2022
(86) PCT No.: PCT/KR2022/016000

§ 371 Date: Apr. 15, 2024

(30) Foreign Application Priority Data
Oct. 20, 2021 (KR) 10-2021-0140471
Oct. 17, 2022 (KR) 10-2022-0133529

(51) Int. Cl. H01B 11/10; H01B 7/02

(52) U.S. Cl. CPC H01B 11/1033; H01B 7/02

(57) ABSTRACT

An Ethernet cable includes: a pair of corers including an insulator covering a conductor, and twisted with each other; a shielding layer covering the pair of cores: a bedding layer filling an empty space between the shielding layer and the pair of cores; and an outer skin layer formed on an exterior of the shielding layer.

### CROSS-REFERENCE TO RELATED APPLICATIONS

The present application is a National Stage of International Application No. PCT/KR2022/016000 filed on Oct. 20, 2022, which claims the benefit of Korean Patent Application No. 10-2021-0140471 filed Oct. 20, 2021, and Korean Patent Application No. 10-2022-0133529, filed on Oct. 17, 2022 with the Korean Intellectual Property Office, the entire contents of which are hereby incorporated by reference.

### FIELD

The present disclosure relates to an Ethernet cable, and more particularly, to an Ethernet cable that can efficiently transmit and receive a large amount of data by removing attenuation amount distortion.

### BACKGROUND

As the automotive Ethernet market is gradually expanding due to recent developments in autonomous driving and infotainment, the demand for automotive Ethernet cables is also increasing. Currently, Ethernet cables are mainly applied to high-end car models, but it is expected that the Ethernet cables will expand to most car models in the future due to the popularization of technology.

Cables for data communication can be broadly divided into coaxial cables, optical cables, and Ethernet cables. Among these cables, the coaxial cables are used in various fields due to high safety thereof, but are not suitable for high-speed data communication due to low transmission speed and small transmission capacity thereof. The optical cables are used for high-speed data communication with very high transmission speeds, but have the disadvantages of poor durability, high system construction costs, and being greatly affected by temperature.

The Ethernet cables are largely divided into Unshielded Twisted Pair (UTP) and Shielded Twisted Pair (STP), and as the STP has better noise characteristics due to shielding than the UTP, the development of high-performance Ethernet cables is progressing towards an STP structure.

In developing the high-performance Ethernet cables, in order to transmit large-capacity/high-speed data, a frequency bandwidth must be designed to be expanded by increasing a frequency limit of the cable. However, as the frequency limit is increased, various distortions occur due to unexpected electrical properties, and there is a need to develop technology to remove various distortions to satisfy electrical properties.

### SUMMARY

Accordingly, the present disclosure provides an Ethernet cable that can efficiently transmit and receive a large amount of data by removing attenuation amount distortion.

In order to implement an object of the present disclosure, an Ethernet cable according to an embodiment includes: a pair of corers including an insulator covering a conductor, and twisted with each other: a shielding layer covering the pair of cores: a bedding layer filling an empty space between the shielding layer and the pair of cores; and an outer skin layer formed on an exterior of the shielding layer.

In an embodiment of the present disclosure, in the conductor, six conductor wires may be arranged around one central wire.

In an embodiment of the present disclosure, a twisted pairing pitch of the pair of cores may be 7 mm or more and 10 mm or less.

In an embodiment of the present disclosure, the shielding layer may include a first shielding layer formed on the bedding layer, and a second shielding layer formed on the first shielding layer.

In an embodiment of the present disclosure, the first shielding layer may include an aluminum tape, and the second shielding layer may include a metal braid.

In an embodiment of the present disclosure, the aluminum tape may include an aluminum (Al)-mylar, and the metal braid may include a tin-plated copper braid.

In an embodiment of the present disclosure, an average diameter of the insulator and an average diameter of the bedding layer may be defined by the following equation.

$${10}^{6} \cdot {e}^{( - 16.12 \cdot a )} + 2.5 \leq b \leq {10}^{7} \cdot {e}^{( - 16.65 \cdot a )} + 2.9$$

(Where a represents the average diameter of the insulator and b represents the average diameter of the bedding layer.)

According to the present disclosure, attenuation amount distortion is moved by forming a bedding layer between an insulator and a shielding layer of an Ethernet cable to prevent the attenuation amount distortion in a frequency bandwidth required to use the Ethernet cable. Accordingly, large-capacity and high-speed data transmission can be performed efficiently.

Further, a diameter of the insulator and a diameter of the bedding layer of the Ethernet cable are adjusted to satisfy a characteristic impedance differential mode (CIDM) condition for appropriate performance of the Ethernet cable.

### BRIEF DESCRIPTION OF THE DRAWINGS

FIG. 1 is a cross-sectional view illustrating an Ethernet cable in the related art.

FIG. 2 is a cross-sectional view illustrating an Ethernet cable according to an embodiment of the present disclosure.

FIG. 3 is a cross-sectional view illustrating an Ethernet cable according to an embodiment of the present disclosure.

FIG. 4 is a perspective view illustrating conductors of a pair of cores of the Ethernet cable according to an embodiment of the present disclosure.

FIG. 5 is a graph showing attenuation amount distortion of the Ethernet cable according to an embodiment of the present disclosure and the Ethernet cable in the related art.

### DETAILED DESCRIPTION

The present disclosure can be variously modified, and can have various forms, so embodiments are intended to be described in detail in a text. However, this does not limit the present disclosure to specific embodiments, and it should be understood that the present disclosure covers all the modifications, equivalents and replacements included within the idea and technical scope of the present disclosure. While describing each drawing, similar reference numerals are used for similar components. Terms including as first, second, and the like are used for describing various components, but the components should not be limited by the terms.

The terms are used only to discriminate one component from another component. Terms used in the present application are used only to describe specific embodiments, and are not intended to limit the present disclosure. A singular form includes a plural form if there is no clearly opposite meaning in the context.

In the present application, it should be understood that the term “include” or “is constituted by” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

Hereinafter, preferred embodiments of the present disclosure will be described in more detail with reference to the accompanying drawings.

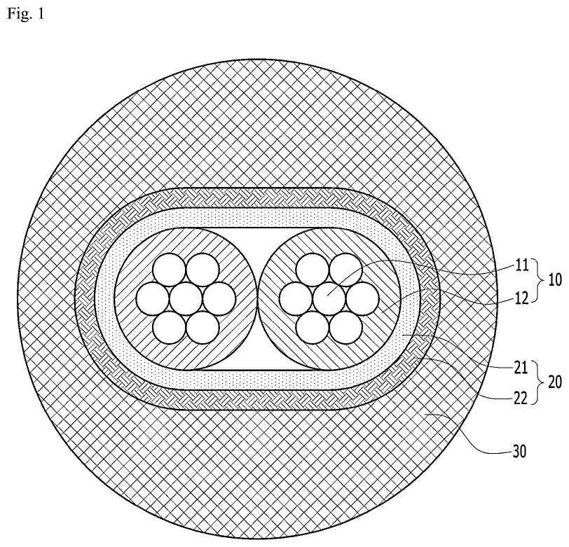

FIG. 1 is a cross-sectional view illustrating an Ethernet cable in the related art.

Referring to FIG. 1, the Ethernet cable in the related art may include a core 10, a shielding layer 20, and an outer skin layer 30.

The core 10 may be formed as a pair including an insulator 12 covering a conductor 11. The shielding layer 20 may be formed to cover the pair of cores 10.

The shielding layer 20 may include a first shielding layer 21 and a second shielding layer 22. The first shielding layer 21 may include an aluminum tape, and the second shielding layer 22 may include a metal braid.

The shielding layer 20 may perform a function of reflecting or absorbing electromagnetic waves emitted to the outside from the pair of cores 10 and electromagnetic waves trying to penetrate into the Ethernet cable according to an embodiment of the present disclosure from the outside, and blocking the electromagnetic waves.

The outer skin layer 30 may perform a function of completely covering the pair of cores 10 and protecting the core 10 from external pressure or impact.

In the Ethernet cable in the related art, only the shielding layer 20 is formed between the pair of cores 10 and the outer skin layer 30. Accordingly, when the Ethernet cable is bent, it is difficult to maintain the pitch of the pair of cores 10, causing a problem in that the structure of the Ethernet cable may not be maintained stably.

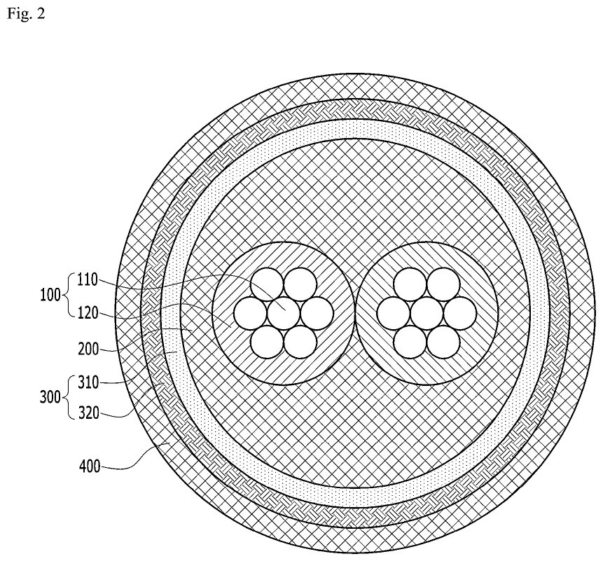

FIG. 2 is a cross-sectional view illustrating an Ethernet cable according to an embodiment of the present disclosure.

Referring to FIG. 2, the Ethernet cable according to an embodiment of the present disclosure may include a core 100, a bedding layer 200, a shielding layer 300, and an outer skin layer 400.

The core 100 may be formed as a pair including an insulator 120 covering a conductor 110.

The conductor 110 may be formed in a shape in which six conductor wires are arranged around one central wire. The conductor 110 may be made of a metal material such as copper, aluminum, or silver, or an alloy thereof.

The insulator 120 may be formed by extrusion of an insulating composition containing a polymer resin having an electrical insulating property as a base resin. The polymer resin is not particularly limited as long as the polymer resin may implement the electrical insulating property, but may include, for example, polyolefin resins such as polyethylene, ethylene vinyl acetate, ethylene ethyl acetate, and ethylene butylacrylate.

The bedding layer 200 may be arranged to fill an empty space between the shielding layer and the pair of cores. The bedding layer 200 may fill the empty space between the pair of cores 100 and the shielding layer 300 to enhance the roundness of the Ethernet cable and structurally stabilize the Ethernet cable. Further, the bedding layer 200 may perform a function of enhance a communication property such as maintaining a gap between the pair of cores 100 and the shielding layer 300, and the resulting impedance constant.

The bedding layer 200 may be made of any one or more resins such as polyvinyl chloride (PVC), polyethylene (PE), cross-linked polyethylene (XLPE), polypropylene (PP), and fluorinated ethylene propylene (FEP). The bedding layer 200 using the resins serves to increase a dielectric constant outside the core 100 and increase a physical distance between the core and the shielding layer, so a point with attenuation amount distortion is changed to a higher frequency band than the Ethernet cable in the related art by changing the overall effective dielectric constant and capacitor value, thereby preventing the attenuation amount distortion in a required frequency bandwidth.

The shielding layer 300 may perform a function of covering the pair of cores 100, and reflecting or absorbing the electromagnetic waves emitted to the outside from the pair of cores 100 and the electromagnetic waves trying to penetrate into the Ethernet cable according to an embodiment of the present disclosure from the outside, and blocking the electromagnetic waves.

The shielding layer 300 may include a first shielding layer 310 and a second shielding layer 320.

The first shielding layer 310 may be formed on the bedding layer 200. The first shielding layer 310 may include an aluminum tape. For example, the first shielding layer 310 may be an aluminum tape, such as an aluminum such as an aluminum (Al)-mylar tape in which an aluminum foil is attached to a polyester film.

The second shielding layer 320 may be formed on the first shielding layer 310. The second shielding layer 320 may include a metal braid. For example, the second shielding layer 320 may be a metal braid, such as a tin-plated copper braid.

The outer skin layer 400 may be formed on an exterior of the shielding layer 300. The outer skin layer 400 may perform a function of completely covering the pair of cores 100 and protecting the core 100 from external pressure or impact. For example, the outer skin layer 400 may be formed by extrusion of an outer skin composition containing polyvinyl chloride resin, polyethylene resin, fluorine resin, etc., preferably polyvinyl chloride resin with excellent flexibility, as a base resin.

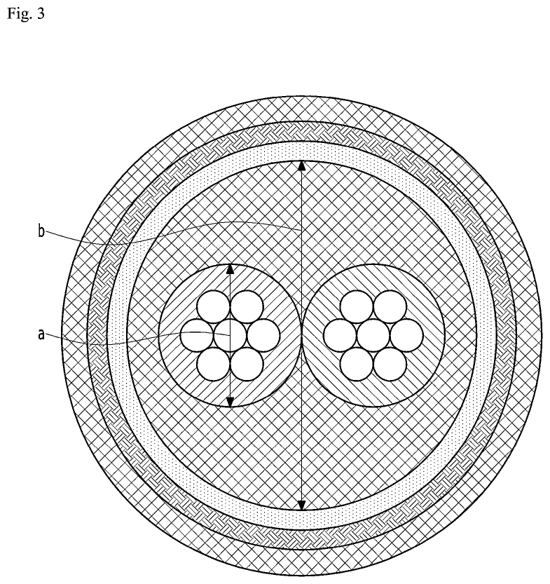

FIG. 3 is a cross-sectional view illustrating an Ethernet cable according to an embodiment of the present disclosure.

Referring to FIGS. 2 and 3, the Ethernet cable according to an embodiment of the present disclosure may include the core 100, the bedding layer 200, the shielding layer 300, and the outer skin layer 400. The core 100 may include the insulator 120 covering the conductor 110.

In the embodiment, the insulator 120 may be formed to have a first diameter a and the bedding layer 200 may be formed to have a second diameter b. The diameter of the insulator 120 and the diameter of the bedding layer 200 may influence a characteristic impedance differential mode (CIDM).

An average diameter a of the insulator 120 and an average diameter b of the bedding layer 200 according to an embodiment of the present disclosure may be determined by Equation 1 below.

$${10}^{6} \cdot {e}^{( - 16.12 \cdot a )} + 2.5 \leq b \leq {10}^{7} \cdot {e}^{( - 16.65 \cdot a )} + 2.9 \qquad Equation 1$$

(Where a represents the average diameter of the insulator and b represents the average diameter of the bedding layer.)

The average diameter a of the insulator 120 and the average diameter b of the bedding layer 200 may be determined by Equation 1 above, and as a result, the characteristic impedance differential mode (CIDM) may satisfy 100Ω±3% required for the Ethernet cable.

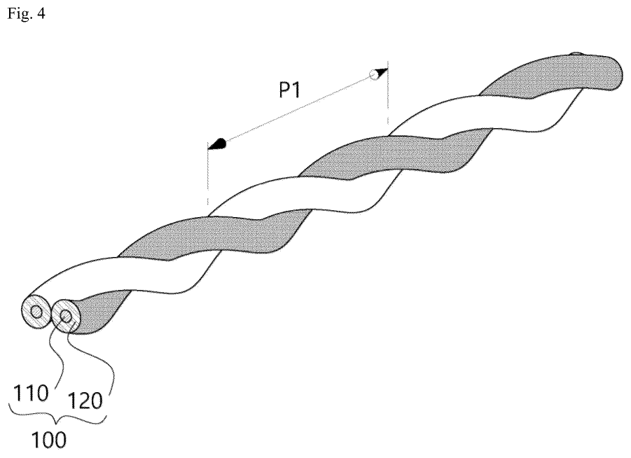

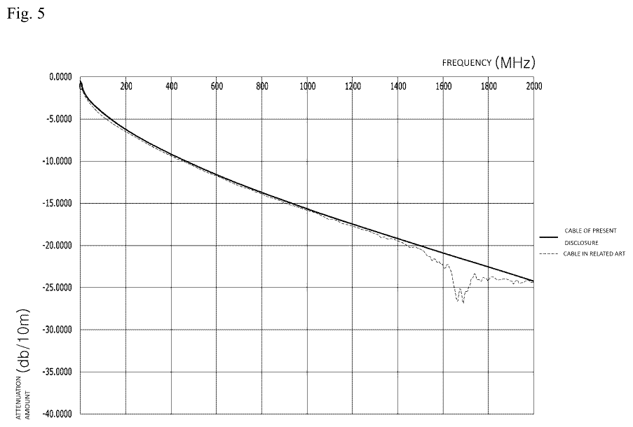

FIG. 4 is a perspective view illustrating conductors of a pair of cores of the Ethernet cable according to an embodiment of the present disclosure. FIG. 5 is a graph showing attenuation amount distortion of the Ethernet cable according to an embodiment of the present disclosure and the Ethernet cable in the related art.

Referring to FIG. 4, the core of the Ethernet cable according to an embodiment of the present disclosure includes a conductor 110.

The conductor 110 may have six conductor wires arranged around one central wire. At this time, a twisted pairing pitch P1 at which a pair of cores 100 are twisted together may be 7 mm or more and 10 mm or less. As the twisted pairing pitch becomes shorter, a point at which the attenuation amount distortion occurs moves to a higher frequency. For example, in the case of the cable in the related art illustrated in FIG. 5, the attenuation amount distortion occurs at a point of 1.7 GHZ, but when the bedding layer 200 is included and the twisted pairing pitch is formed shorter, the point at which the attenuation amount distortion occurs may move to a value larger than 1.7 GHz.

However, as the twisted pairing pitch of the Ethernet cable according to an embodiment of the present disclosure becomes shorter, an ability of the bedding layer 200 to fill valleys where a pair of cores 100 are twisted together may decrease. Therefore, preferably, the twisted pairing pitch may be 7 mm or more and 10 mm or less.

Referring to FIG. 5, occurrence states of the attenuation amount distortion of the Ethernet cable according to an embodiment of the present disclosure and the cable in the related art may be confirmed.

The cable in the related art is an Ethernet cable in which the bedding layer is not formed and the twist pairing pitch is 10 mm, and the Ethernet cable according to an embodiment of the present disclosure is a cable in which the bedding layer 200 is formed and the twist pairing pitch is 10 mm. It can be seen that in the cable in the related art, the attenuation amount distortion occurs at a point of 1700 MHz point, but in the Ethernet cable according to an embodiment of the present disclosure, the bedding layer 200 is formed and the attenuation amount distortion occurrence point moves to a value greater than 1700 MHZ, causing no distortion within a target frequency.

### Examples

CIDM values were obtained by testing an Ethernet cable configured according to Table 1 below.

A twisted pairing pitch PI at which a pair of cores 100 are twisted together was fixed at 8.5 mm, an average diameter a of the insulator was fixed at 0.9 mm, and then it was checked whether the CIDM value satisfied required 100Ω±3% while changing an average diameter of the bedding layer. The experiment was conducted on 0.5 m and 1.5 m Ethernet cables, respectively, and it was checked whether both the 0.5 m and 1.5 m Ethernet cables satisfied the required CIDM.

In Equation 1 below in which the average diameter a of the insulator 120 and the average diameter b of the bedding layer 200 according to an embodiment of the present disclosure are determined, it can be seen that the average diameter b of the bedding layer is 3.000329 mm≤b≤6.005254 mm when the average diameter a of the insulator 120 is 0.9 mm.

$${10}^{6} \cdot {e}^{( - 16.12 \cdot a )} + 2.5 \leq b \leq {10}^{7} \cdot {e}^{( - 16.65 \cdot a )} + 2.9 \qquad Equation 1$$

(Where a represents the average diameter of the insulator and b represents the average diameter of the bedding layer.)

| | Twisted | Insulating | Bedding | | |
|---|---|---|---|---|---|
| | paring pitch | diameter [a] | diameter [b] | CIDM (Ω) | |
| | [P1] mm | mm | mm | 0.5m | 1.5m |
| Example 1 | 8.5 | 0.9 | 4 | 99.36 | 100.43 |
| Example 2 | 8.5 | 0.9 | 4.5 | 100.72 | 101.79 |
| Example 3 | 8.5 | 0.9 | 5 | 101.74 | 102.8 |
| Comparative | 8.5 | 0.9 | 2.1 | 80.05 | 81.09 |
| Example 1 | | | | | |
| Comparative | 8.5 | 0.9 | 2.4 | 86.73 | 87.83 |
| Example 2 | | | | | |
| Comparative | 8.5 | 0.9 | 6.6 | 103.49 | 104.56 |
| Example 3 | | | | | |
| Comparative | 8.5 | 0.9 | 6.9 | 103.68 | 104.74 |
| Example 4 | | | | | |

As summarized in Table 1 above, Ethernet cables in Examples 1 to 3 according to the present disclosure satisfied the required CIDM because the CIDM showed values within the required 100 Ω±3% On the other hand, in Comparative Examples 1 and 2, it could be seen that there was a problem in that the average diameter of the bedding layer was less than 3.000329 mm, which is a lower limit reference of Equation 1, so the CIDM was smaller than 100Ω±3%, and in Comparative Examples 3 and 4, it could be seen that there was a problem in that the average diameter of the bedding layer was more than 6.005254 mm, which is an upper limit reference of Equation 1, so the CIDM was larger than 100Ω±3%

The present disclosure has been described with reference to the embodiments. However, it will be appreciated by those skilled in the art that various modifications and changes of the present disclosure can be made without departing from the spirit and the scope of the present disclosure which are defined in the appended claims and their equivalents.

1. An Ethernet cable comprising:
a pair of corers including an insulator covering a conductor, and twisted with each other;
a shielding layer covering the pair of cores;
a bedding layer filling an empty space between the shielding layer and the pair of cores; and
an outer skin layer formed on an exterior of the shielding layer.

2. The Ethernet cable of claim 1, wherein in the conductor, six conductor wires are arranged around one central wire.

3. The Ethernet cable of claim 1, wherein a twisted pairing pitch of the pair of cores is 7 mm or more and 10 mm or less.

4. The Ethernet cable of claim 1, wherein the shielding layer includes
a first shielding layer formed on the bedding layer, and
a second shielding layer formed on the first shielding layer.

5. The Ethernet cable of claim 4, wherein the first shielding layer includes an aluminum tape, and the second shielding layer includes a metal braid.

6. The Ethernet cable of claim 5, wherein the aluminum tape includes an aluminum (Al)-mylar, and the metal braid includes a tin-plated copper braid.

7. The Ethernet cable of claim 1, wherein an average diameter of the insulator and an average diameter of the bedding layer are defined by the following equation.
$${10}^{6} \cdot {e}^{( - 16.12 \cdot a )} + 2.5 \leq b \leq {10}^{7} \cdot {e}^{( - 16.65 \cdot a )} + 2.9$$
(Where a represents the average diameter of the insulator and b represents the average diameter of the bedding layer.)

8. The Ethernet cable of claim 1, wherein the bedding layer is made of any one or more resins such as polyvinyl chloride (PVC), polyethylene (PE), cross-linked polyethylene (XLPE), polypropylene (PP), and fluorinated ethylene propylene (FEP).
